(19) United States
(12) Patent Application Publication
(10) Pub. No.: US 2026/0039782 A1
(43) Pub. Date: Feb. 5, 2026

(54) MOUNTING AND DISMOUNTING ROUTINES

(71) Applicant: Apple Inc., Cupertino, CA (US)

(72) Inventors: Yutaka Yokokawa, Los Gatos, CA (US); Alexandria G. Heston, San Francisco, CA (US); In Young Yang, Kirkland, WA (US); Joshua J. Frost, Aptos, CA (US); Magnus H. Johnson, San Francisco, CA (US)

(21) Appl. No.: 19/285,348

(22) Filed: Jul. 30, 2025

Related U.S. Application Data
(60) Provisional application No. 63/677,744, filed on Jul. 31, 2024.

(51) Int. Cl. H04N 13/366; H04N 13/332; H04N 13/361; H04N 13/398

(52) U.S. Cl. CPC H04N 13/366; H04N 13/332; H04N 13/361; H04N 13/398

(57) ABSTRACT

In one implementation, a method of executing a routine is performed by a head-mountable device having one or more processors and non-transitory memory. The method includes detecting a trigger indicating that a user has mounted or dismounted the head-mountable device. The method includes, in response to detecting the trigger, executing a routine including transmitting a request to change a state of a remote device from a first state to a second state.

### CROSS-REFERENCE TO RELATED APPLICATIONS

This application claims priority to U.S. Provisional Patent App. No. 63/677,744, filed on Jul. 31, 2024, which is hereby incorporated by reference in its entirety.

### TECHNICAL FIELD

The present disclosure generally relates to systems, methods, and devices of triggering a routine based on detecting mounting and/or dismounting of a head-mountable device.

### BACKGROUND

In various implementations, a user can program a routine to be executed in response to detecting a trigger. The routine may include transmission of requests to smart devices to change states.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example operating environment in accordance with some implementations.

FIGS. 2A-21 illustrate a user view during various time periods in accordance with some implementations.

FIG. 3 is a flowchart representation of a method of triggering a routine in accordance with some implementations.

FIG. 4 is a block diagram of an example controller in accordance with some implementations.

FIG. 5 is a block diagram of an example electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for executing a routine. In various implementations, the method is performed by a head-mountable device having one or more processors and non-transitory memory. The method includes detecting a trigger indicating that a user has mounted or dismounted the head-mountable device. The method includes, in response to detecting the trigger, executing a routine including transmitting a request to change a state of a remote device from a first state to a second state.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

As noted above, in various implementations, a user can program a device to execute a routine in response to detecting a trigger. Executing the routine may include, for example, transmitting requests to smart devices to change states, playing audio, or display information. As discussed herein, a routine is executed by a head-mountable device in response to detecting that a user has mounted or dismounted the head-mountable device. In particular, mounting includes placing the head-mountable device upon the user's head and dismounting includes removing the head-mountable device from the user's head. In various implementations, mounting the head-mountable device may be referred to as donning (or putting on) the head-mountable device and dismounting the head-mountable device may be referred to as doffing (or taking off) the head-mountable device.

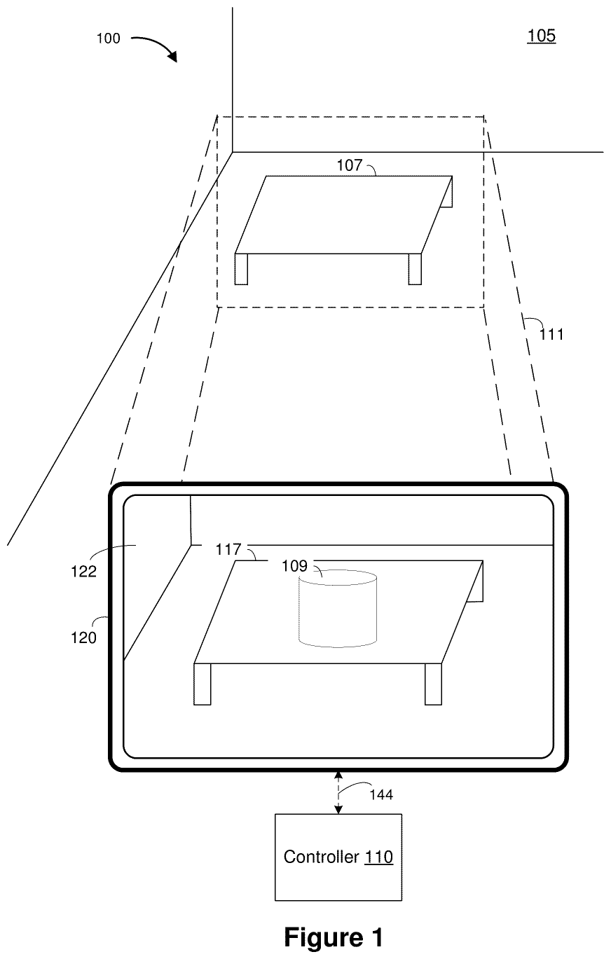

FIG. 1 is a block diagram of an example operating environment 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 100 includes a controller 110 and an electronic device 120.

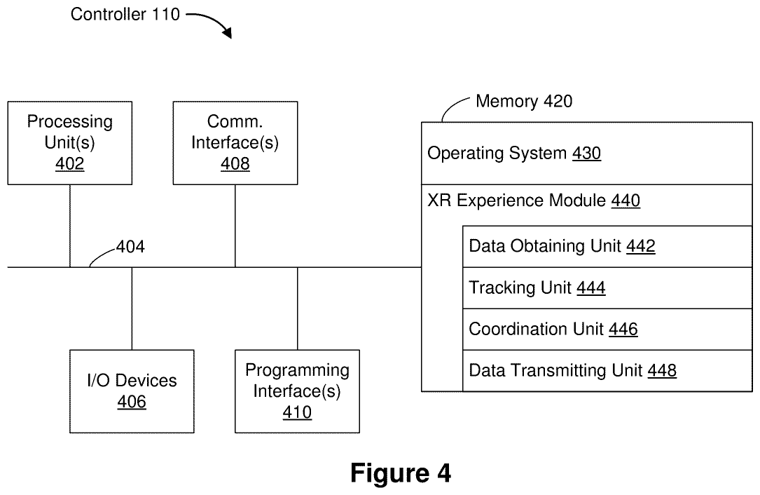

In some implementations, the controller 110 is configured to manage and coordinate an XR experience for the user. In some implementations, the controller 110 includes a suitable combination of software, firmware, and/or hardware. The controller 110 is described in greater detail below with respect to FIG. 4. In some implementations, the controller 110 is a computing device that is local or remote relative to the physical environment 105. For example, the controller 110 is a local server located within the physical environment 105. In another example, the controller 110 is a remote server located outside of the physical environment 105 (e.g., a cloud server, central server, etc.). In some implementations, the controller 110 is communicatively coupled with the electronic device 120 via one or more wired or wireless communication channels 144 (e.g., BLUETOOTH, IEEE 802.11x, IEEE 802.16x, IEEE 802.3x, etc.). In another example, the controller 110 is included within the enclosure of the electronic device 120. In some implementations, the functionalities of the controller 110 are provided by and/or combined with the electronic device 120.

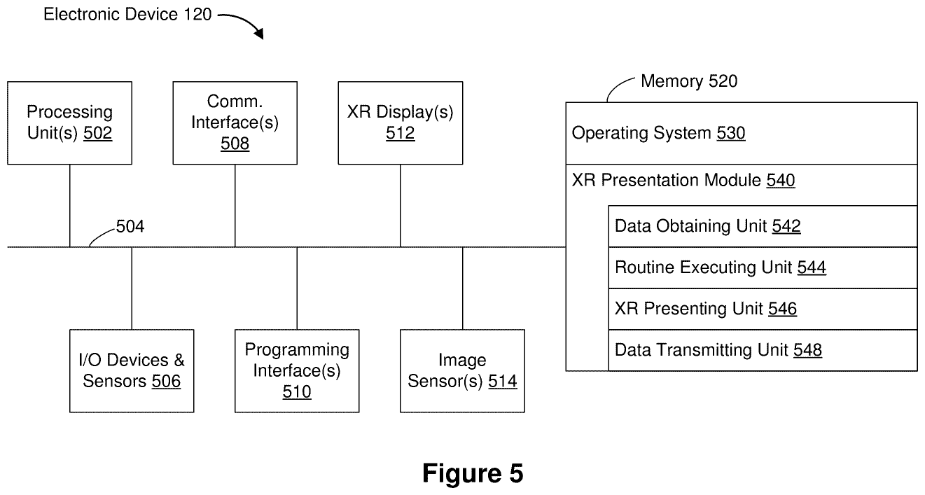

In some implementations, the electronic device 120 is configured to provide the XR experience to the user. In some implementations, the electronic device 120 includes a suitable combination of software, firmware, and/or hardware. According to some implementations, the electronic device 120 presents, via a display 122, XR content to the user while the user is physically present within the physical environment 105 that includes a table 107 within the field-of-view 111 of the electronic device 120. As such, in some implementations, the user holds the electronic device 120 in his/her hand(s). In some implementations, while providing XR content, the electronic device 120 is configured to display an XR object (e.g., an XR cylinder 109) and to enable video pass-through of the physical environment 105 (e.g., including a representation 117 of the table 107) on a display 122. The electronic device 120 is described in greater detail below with respect to FIG. 5.

According to some implementations, the electronic device 120 provides an XR experience to the user while the user is virtually and/or physically present within the physical environment 105.

In some implementations, the user wears the electronic device 120 on his/her head. For example, in some implementations, the electronic device includes a head-mounted system (HMS), head-mounted device (HMD), or head-mounted enclosure (HME). As such, the electronic device 120 includes one or more XR displays provided to display the XR content. For example, in various implementations, the electronic device 120 encloses the field-of-view of the user. In some implementations, the electronic device 120 is a handheld device (such as a smartphone or tablet) configured to present XR content, and rather than wearing the electronic device 120, the user holds the device with a display directed towards the field-of-view of the user and a camera directed towards the physical environment 105. In some implementations, the handheld device can be placed within an enclosure that can be worn on the head of the user. In some implementations, the electronic device 120 is replaced with an XR chamber, enclosure, or room configured to present XR content in which the user does not wear or hold the electronic device 120.

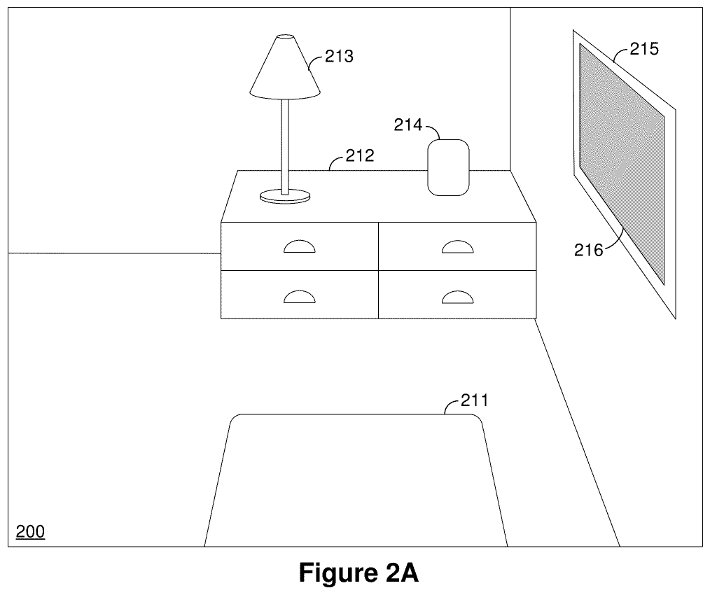

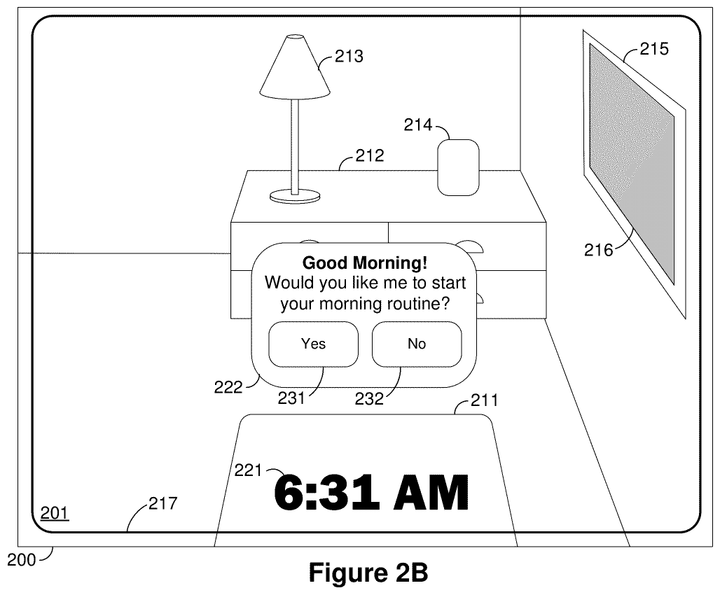

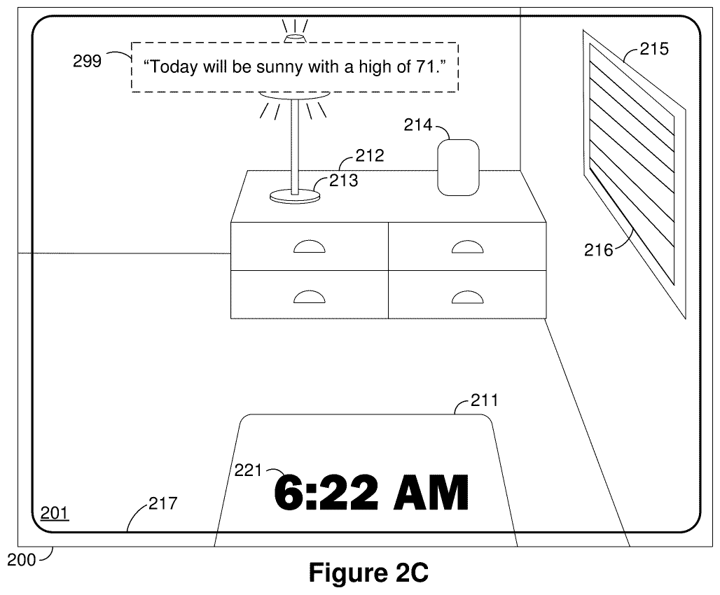

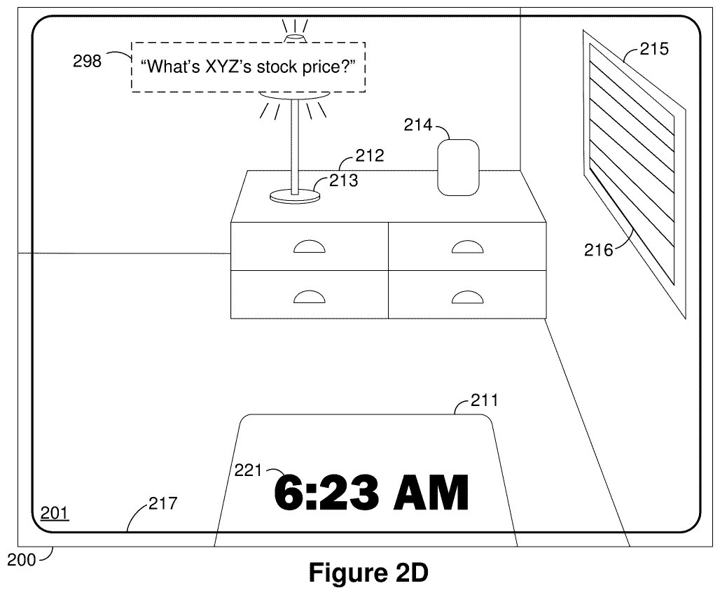

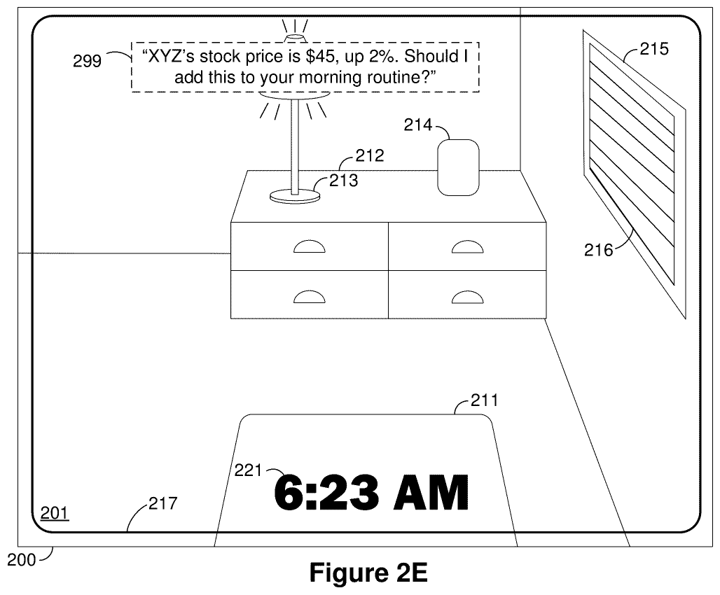

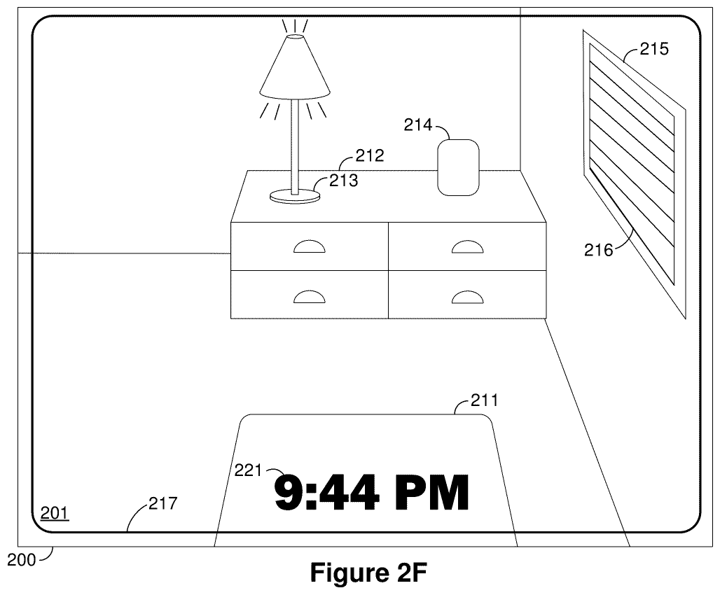

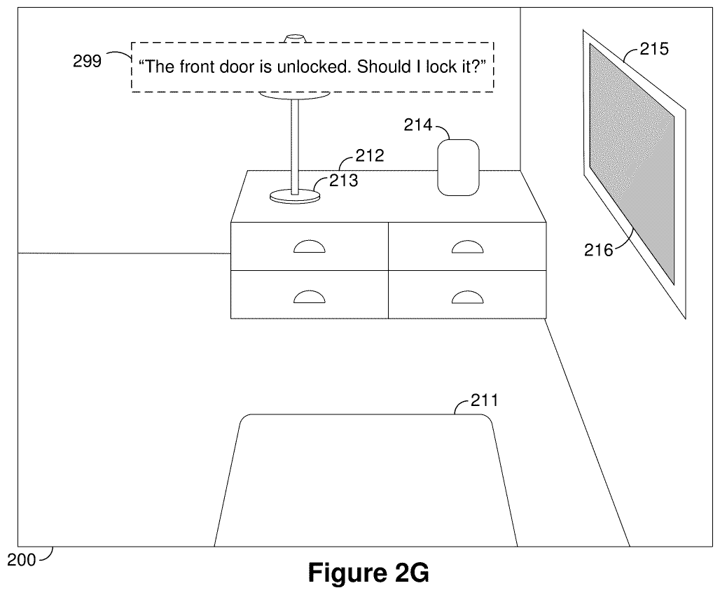

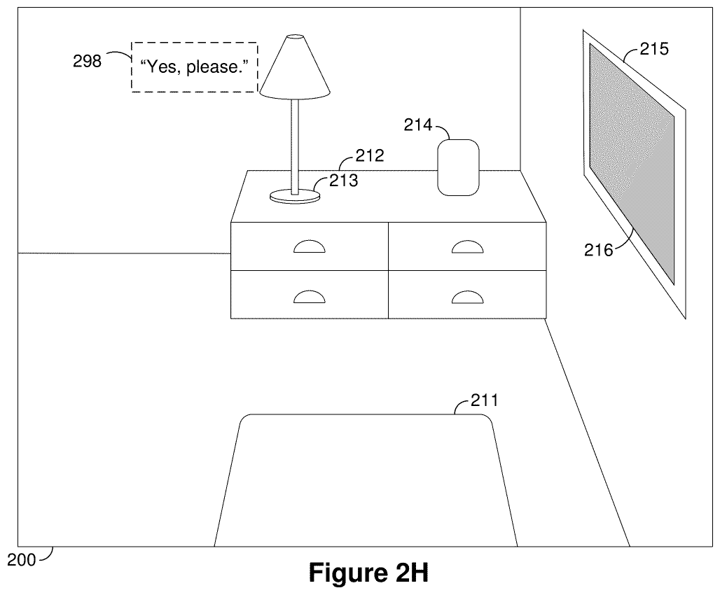

FIGS. 2A-21 illustrate a physical environment 200 of a bedroom during a series of time periods. In various implementations, each time period is an instant, a fraction of a second, a few seconds, a few hours, a few days, or any length of time. The physical environment 200 includes a bed 211, a dresser 212, a lamp 213, a speaker 214, a window 215, and blinds 216 over the window 215.

FIG. 2A illustrates the physical environment 200 during a first time period. During the first time period, the lamp 213 is an “off” state and the blinds 216 are in a “closed” state.

FIG. 2B illustrates the physical environment 200 during a second time period subsequent to the first time period. Between the first time period and the second time period, a user has mounted a head-mountable device 217. Accordingly, during the second time period, the physical environment 200 includes the head-mountable device 217 presenting an XR environment 201 based on the physical environment 200.

The XR environment 201 includes a plurality of objects, including one or more real objects (e.g., the bed 211, the dresser 212, the lamp 213, the speaker 214, the window 215, and the blinds 216) and one or more virtual objects (e.g., a virtual clock 221 and a virtual confirmation window 222). In various implementations, certain objects (such as the real objects and the virtual confirmation window 222) are presented at a location in the XR environment 201, e.g., at a location defined by three coordinates in a three-dimensional (3D) XR coordinate system. Accordingly, when the head-mountable device 217 moves in the XR environment 201 (e.g., changes either position and/or orientation), the objects are moved on the display of the head-mountable device, but retain their (possibly time-dependent) location in the XR environment 201. Such virtual objects that, in response to motion of the head-mountable device, move on the display, but retain their position in the XR environment 201 are referred to as world-locked objects. In various implementations, certain virtual objects (such as the virtual clock 221) are displayed at locations on the display such that when the head-mountable device moves in the XR environment 201, the objects are stationary on the display on the electronic device. Such virtual objects that, in response to motion of the head-mountable device, retain their location on the display are referred to as head-locked objects or display-locked objects.

During the second time period, in response to detecting that the user has mounted the head-mountable device 217, the head-mountable device executes a mounting routine. The mounting routine includes displaying the virtual confirmation window 222. The virtual confirmation window 222 includes a yes affordance 231 for continuing the mounting routine and a no affordance 232 for ceasing the mounting routine. During the second time period, the user selects the yes affordance 231. In various implementations, the user selects the yes affordance 231 by gazing at the yes affordance and performing a hand gesture (e.g., contacting a thumb and index finger). In various implementations, the user selects the yes affordance 231 by verbally saying “yes”.

FIG. 2C illustrates the physical environment 200 at a third time period subsequent to the second time period. During the third time period, in response to detecting the user selecting the yes affordance 231, the head-mountable device 217 continues the mounting routine by transmitting a command to the lamp 213 to change to an “on” state, transmitting a command to the blinds 216 to change to an “open” state, and playing audio (illustrated in FIG. 2C by the optionally displayed audio playback indicator 299) indicating a current weather status. Thus, during the third time period, the lamp 213 is in the “on” state and the blinds 216 are in the “open” state.

Although FIG. 2B illustrates a virtual confirmation window 222, in various implementations, the mounting routine does not include display of the virtual confirmation window 222. Accordingly, in various implementations, in response to detecting that the user has mounted the head-mountable device 217, the head-mountable device 217 automatically transmits the command to the lamp 213 to change to an “on” state, transmits the command to the blinds 216 to change to an “open” state, and plays the audio indicating the current weather status. In various implementations, rather than a virtual confirmation window 222, the head-mountable device 217 audibly requests confirmation to execute the mounting routine.

FIG. 2D illustrates the physical environment 200 at a fourth time period subsequent to the third time period. During the fourth time period, the head-mountable device 217 detects the user speaking (illustrated in FIG. 2D by the optionally displayed audio detection indicator 298) requesting a current stock status.

FIG. 2E illustrates the physical environment 200 at a fifth time period subsequent to the fourth time period. During the fifth time period, the head-mountable device 217 plays audio (as indicated by the optionally displayed audio playback indicator 299) indicative of the current stock status and further audio suggesting a change to the mounting routine. In various implementations, the head-mountable device suggests changing the mounting routine based on user actions often performed shortly after mounting the head-mountable device 217. In response to the user confirming the change, the head-mountable device 217 changes the mounting routine to include playing audio indicating the current stock status.

FIG. 2F illustrates the physical environment 200 at a sixth time period subsequent to the fifth time period. During the sixth time period, the head-mountable device 217 determines a confidence that the user will soon dismount the head-mountable device 217. In various implementations, the head-mountable device 217 determines the confidence based on a time of day (e.g., the confidence is higher if it is late evening or a time of day the user typically dismounts the head-mountable device 217). In various implementations, the head-mountable device 217 determines the confidence based on location (e.g., the confidence is higher if the user has returned to the bedroom after being absent for a long period of time). In various implementations, the head-mountable device 217 determines the confidence based on data received from other devices (e.g., the confidence is higher if the data includes an indication that a user has set a phone to charge or dismounted a watch).

In various implementations, if the confidence breaches a threshold, the head-mountable device 217 triggers a dismounting routine in advance of detecting that the user has dismounted the head-mountable device. In various implementations, the dismounting routine includes displaying a virtual confirmation window similar to the virtual confirmation window 222 of the mounting routine. However, in various implementations, the dismounting routine does not include displaying a virtual confirmation window.

FIG. 2G illustrates the physical environment 200 at a seventh time period subsequent to the sixth time period. Between the sixth time period and the seventh time period, the user has dismounted the head-mountable device 217. During the seventh time period, in response to detecting that the user has dismounted the head-mountable device 217, the head-mountable device triggers the dismounting routine. In various implementations, the dismounting routine includes transmitting a command to the lamp 213 to change to the “off” state and transmitting a command to the blinds 216 to change to the “closed” state. Accordingly, during the seventh time period, the lamp 213 is in the “off” state and the blinds 216 are in the “closed” state.

During the seventh time period, the head-mountable device 217 suggests performing an additional action of transmitting a command to a lock to change to a “locked” state by playing audio (as illustrated by the audio playback indicator 299) suggesting the additional action. In various implementations, the head-mountable device 217 suggest performing the additional action by transmitting a command to the speaker 214 to play the audio.

FIG. 2H illustrates the physical environment 200 during an eighth time period subsequent to the seventh time period. During the eighth time period, the user verbally confirms (as illustrated by the audio detection indicator 298) that the head-mountable device is to perform the additional action. In response to detecting the confirmation, the head-mountable device transmits the command to the lock to change to the “locked” state.

FIG. 2I illustrates the physical environment 200 during a ninth time period subsequent to the eighth time period. During the ninth time period, the head-mountable device 217 plays audio (as indicated by the audio playback indicator 299) suggesting a change to the dismounting routine. In various implementations, the head-mountable device suggests changes the mounting routine based on user actions often performed shortly before and/or after dismounting the head-mountable device 217. In response to the user confirming the change, the head-mountable device 217 changes the dismounting routine to include transmitting a command to the lock to change to an “locked” state.

In various implementations, rather than transmitting commands directly to multiple devices (such as the lamp 213, the blinds 216, and the lock), the head-mountable device 217 performs the dismounting routine by transmitting a dismount notice to the speaker 214. In response to receiving the dismount notice, the speaker 214 furthers the dismounting routine by transmitting commands to the lamp 213, the blinds 216, and the lock.

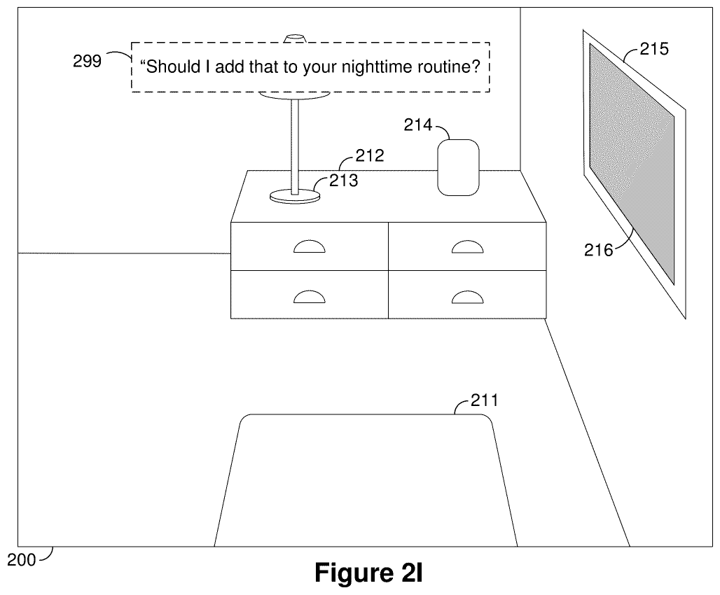

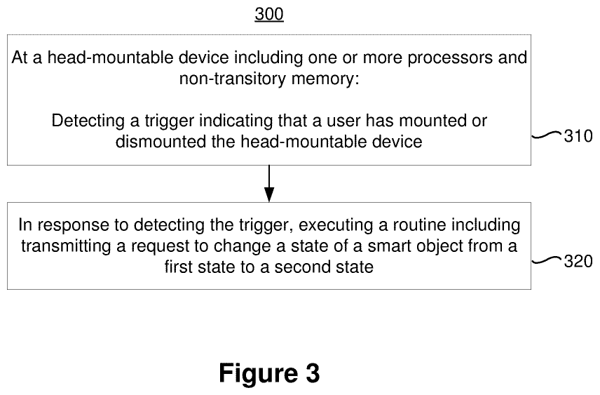

FIG. 3 is a flowchart representation of a method 300 of executing a routine in accordance with some implementations. In various implementations, the method 300 is performed by an electronic device, such as the electronic device 120 of FIG. 1. In various implementations, the method 300 is performed by a head-mountable device having one or more processors and non-transitory memory. In some implementations, the method 300 is performed by processing logic, including hardware, firmware, software, or a combination thereof. In some implementations, the method 300 is performed by a processor executing instructions (e.g., code) stored in a non-transitory computer-readable medium (e.g., a memory).

The method 300 begins, in block 310, with the head-mountable device detecting a trigger indicating that a user has mounted or dismounted the head-mountable device. In various implementations, the trigger indicates that the user has mounted the head-mountable device (e.g., placed the head-mountable device on the user's head). In various implementations, the head-mountable device detects that the user has mounted the head-mountable device using a proximity sensor that determines that the user's head is proximate to the proximity sensor. In various implementations, the head-mountable device detects that the user has mounted the head-mountable device using an image sensor and detecting the user (e.g., the user's eyes) in an image captured by the image sensor.

In various implementations, the trigger indicates that the user has dismounted the head-mountable device (e.g., removed the head-mountable device from the user's head). In various implementations, the head-mountable device detects that the user has dismounted the head-mountable device using a proximity sensor that determines that the user's head is no longer proximate to the proximity sensor. In various implementations, the head-mountable device detects that the user has dismounted the head-mountable device using an image sensor and failing to detect the user (e.g., the user's eyes) in an image captured by the image sensor.

The method 300 continues, in block 320, with the head-mountable device, in response to detecting the trigger, executing a routine including transmitting a request to change a state of remote device from a first state to a second state. In various implementations, the remote device may be a “smart object” that wirelessly receives commands to change states. For example, in FIG. 2C, the head-mountable device 217 has transmitted a request to the lamp 213 to change from an “off” state to an “on” state and has transmitted a request to the blinds 216 to change from a “closed” state to an “open” state. Accordingly, in various implementations, executing the routine includes transmitting requests to change a respective state of a plurality of remote devices.

In various implementations, executing the routine includes playing audio. For example, in FIG. 2C, the head-mountable device 217 plays audio (as indicated by the optionally displayed audio playback indicator 299) indicating a current weather status. As another example, in FIG. 2E, the head-mountable device 217 plays audio (as indicated by the optionally displayed audio playback indicator 299) indicative of a current stock status. Accordingly, in various implementations, the audio is generated based on data retrieved as part of the routine. In various implementations, the audio is self-generated by the head-mountable device. The audio may be preset (e.g., saying “good morning” or playing a song stored on the head-mountable device) or selected from a preset list of options (e.g., saying one of “good night”, “sleep well”, or “get some good rest” or playing one song of a playlist).

In various implementations, executing the routine includes receiving confirmation to continue the routine. For example, in FIG. 2B, the head-mountable device 217 displays the virtual confirmation window 222 and receives selection of the yes affordance 231.

In various implementations, executing the routine includes transmitting an indirect request to another device to transmit a direct request to the remote device to change the state of the remote device from the first state to the second state. For example, in FIG. 2G (in some embodiments), the head-mountable device 217 transmits an indirect request to the speaker 214 to transmit a direct request to the lamp 213 to change the lamp from the “on” state to the “off” state. As another example, in FIG. 2G (in some embodiments), the head-mountable device 217 transmits a dismount notice to the speaker 214 which, in response to receiving the dismount notice, transmits a direct request to the blinds 216 to change the blinds 216 from the “open” state to the “closed” state.

In various implementations, where the trigger indicates that the user has mounted the device, the method 300 further includes detecting a second trigger indicating that the user has dismounted the head-mountable device and, in response to detecting the second trigger, executing a second routine including transmitting a request to change the state of the remote device from the second state to the first state. In various implementations, the second routine includes features of the routine discussed above.

In various implementations, where the trigger indicates that the user has mounted the device, the method 300 further includes, within a predetermined time period after detecting the trigger, detecting a user request to perform a function and, in response to detecting the user request, modifying the routine to include performing the function. For example, in FIG. 2D, the head-mountable device detects the user requesting that the head-mountable device play audio indicating a current stock status. In response to detecting the user request shortly after mounting the head-mountable device 217 (and determining that the user often makes similar requests), the head-mountable device 217 suggests modifying the mounting routine. In response to a user confirmation, the head-mountable device modifies the mounting routine to include playing audio indicating the current stock status. Accordingly, in various implementations, modifying the routine is further performed in response to detecting a user confirmation of the modification.

In various implementations, where the trigger indicates that the user has dismounted the head-mountable device, the method 300 includes, within a predetermined time period before detecting the trigger, detecting a user request to perform a function and, in response to detecting the user request, modifying the routine to include performing the function. In response to detecting the user request shortly before dismounting the head-mountable device (and determining that the user often makes similar requests), the head-mountable device modifies the dismounting routine to include performing the function (optionally after detecting a user confirmation).

In various implementations, where the trigger indicates that the user has dismounted the head-mountable device, the method 300 includes determining a standard state of an additional remote device and determining that a current state of the additional remote device is not the standard state. For example, in FIG. 2G, the head-mountable device 217 determines that a lock is in an “unlocked” state rather than a “locked” state that it is regularly in when the dismounting routine is executed. The method 300 includes, in response to determining that the current state of the additional remote device is not the standard state, transmitting a request to change the state of the additional remote device from the current state to the standard state. For example, in FIG. 2H, the head-mountable device 217 transmits an indirect request to the speaker 214 to play audio requesting that the user confirm that the speaker 214 is to transmit a direct request to the lock to change the lock from an “unlocked” state to a “locked” state.

In various implementations, the method 300 further includes modifying the routine to include transmitting the request to change the state of the additional remote device from the current state to the standard state. For example, in FIG. 2I, in response to a user confirmation to a query played by the speaker 214, the head-mountable device 217 modifies the dismounting routine to include transmitting a request to change the state of the lock from the “unlocked” state to the “locked” state.

In various implementations, the routine or triggering the routine is dependent on time. For example, in various implementations, when dismounting the head-mountable during the day to, for example, clean a lens, the dismounting routine to turn out lights and close blinds is not executed. However, when dismounting the head-mountable device at night to, for example, go to bed, the dismounting routine to turn out the lights and close the blinds is executed.

Accordingly, in various implementations, the method 300 includes determining a time the trigger is detected and determining that the time the trigger is detected is within a predetermined time window, wherein executing the routine is further performed in response to determining that the time of detecting the trigger is within the predefined time window.

In various implementations, the routine or triggering the routine is dependent on location. For example, in various implementations, when mounting the head-mountable device at a hotel while travelling for business, the mounting routine to turn on lights and open blinds at home is not executed. However, when mounting the head-mountable device at home, the mounting routine to turn on the lights and open the blinds is executed.

Accordingly, in various implementations, the method 300 includes determining a location of the head-mounted device when the trigger is detected and determining that the location of the head-mounted device when the trigger is detected is within a predefined area, wherein executing the routine is further performed in response to determining that the location of the head-mounted device when the trigger is detected is within the predefined area.

FIG. 4 is a block diagram of an example of the controller 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the controller 110 includes one or more processing units 402 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 406, one or more communication interfaces 408 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 410, a memory 420, and one or more communication buses 404 for interconnecting these and various other components.

In some implementations, the one or more communication buses 404 include circuitry that interconnects and controls communications between system components. In some implementations, the one or more I/O devices 406 include at least one of a keyboard, a mouse, a touchpad, a joystick, one or more microphones, one or more speakers, one or more image sensors, one or more displays, and/or the like.

The memory 420 includes high-speed random-access memory, such as dynamic random-access memory (DRAM), static random-access memory (SRAM), double-data-rate random-access memory (DDR RAM), or other random-access solid-state memory devices. In some implementations, the memory 420 includes non-volatile memory, such as one or more magnetic disk storage devices, optical disk storage devices, flash memory devices, or other non-volatile solid-state storage devices. The memory 420 optionally includes one or more storage devices remotely located from the one or more processing units 402. The memory 420 comprises a non-transitory computer readable storage medium. In some implementations, the memory 420 or the non-transitory computer readable storage medium of the memory 420 stores the following programs, modules and data structures, or a subset thereof including an optional operating system 430 and an XR experience module 440.

The operating system 430 includes procedures for handling various basic system services and for performing hardware dependent tasks. In some implementations, the XR experience module 440 is configured to manage and coordinate one or more XR experiences for one or more users (e.g., a single XR experience for one or more users, or multiple XR experiences for respective groups of one or more users). To that end, in various implementations, the XR experience module 440 includes a data obtaining unit 442, a tracking unit 444, a coordination unit 446, and a data transmitting unit 448.

In some implementations, the data obtaining unit 442 is configured to obtain data (e.g., presentation data, interaction data, sensor data, location data, etc.) from at least the electronic device 120 of FIG. 1. To that end, in various implementations, the data obtaining unit 442 includes instructions and/or logic therefor, and heuristics and metadata therefor.

In some implementations, the tracking unit 444 is configured to map the physical environment 105 and to track the position/location of at least the electronic device 120 with respect to the physical environment 105 of FIG. 1. To that end, in various implementations, the tracking unit 444 includes instructions and/or logic therefor, and heuristics and metadata therefor.

In some implementations, the coordination unit 446 is configured to manage and coordinate the XR experience presented to the user by the electronic device 120. To that end, in various implementations, the coordination unit 446 includes instructions and/or logic therefor, and heuristics and metadata therefor.

In some implementations, the data transmitting unit 448 is configured to transmit data (e.g., presentation data, location data, etc.) to at least the electronic device 120. To that end, in various implementations, the data transmitting unit 448 includes instructions and/or logic therefor, and heuristics and metadata therefor.

Although the data obtaining unit 442, the tracking unit 444, the coordination unit 446, and the data transmitting unit 448 are shown as residing on a single device (e.g., the controller 110), it should be understood that in other implementations, any combination of the data obtaining unit 442, the tracking unit 444, the coordination unit 446, and the data transmitting unit 448 may be located in separate computing devices.

Moreover, FIG. 4 is intended more as functional description of the various features that may be present in a particular implementation as opposed to a structural schematic of the implementations described herein. As recognized by those of ordinary skill in the art, items shown separately could be combined and some items could be separated. For example, some functional modules shown separately in FIG. 4 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 5 is a block diagram of an example of the electronic device 120 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 120 includes one or more processing units 502 (e.g., microprocessors, ASICs, FPGAs, GPUs, CPUs, processing cores, and/or the like), one or more input/output (I/O) devices and sensors 506, one or more communication interfaces 508 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 510, one or more XR displays 512, one or more optional interior- and/or exterior-facing image sensors 514, a memory 520, and one or more communication buses 504 for interconnecting these and various other components.

In some implementations, the one or more communication buses 504 include circuitry that interconnects and controls communications between system components. In some implementations, the one or more I/O devices and sensors 506 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more XR displays 512 are configured to provide the XR experience to the user. In some implementations, the one or more XR displays 512 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more XR displays 512 correspond to diffractive, reflective, polarized, holographic, etc. waveguide displays. For example, the electronic device 120 includes a single XR display. In another example, the electronic device includes an XR display for each eye of the user. In some implementations, the one or more XR displays 512 are capable of presenting MR and VR content.

In some implementations, the one or more image sensors 514 are configured to obtain image data that corresponds to at least a portion of the face of the user that includes the eyes of the user (any may be referred to as an eye-tracking camera). In some implementations, the one or more image sensors 514 are configured to be forward-facing so as to obtain image data that corresponds to the physical environment as would be viewed by the user if the electronic device 120 was not present (and may be referred to as a scene camera). The one or more optional image sensors 514 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 520 includes high-speed random-access memory, such as DRAM, SRAM, DDR RAM, or other random-access solid-state memory devices. In some implementations, the memory 520 includes non-volatile memory, such as one or more magnetic disk storage devices, optical disk storage devices, flash memory devices, or other non-volatile solid-state storage devices. The memory 520 optionally includes one or more storage devices remotely located from the one or more processing units 502. The memory 520 comprises a non-transitory computer readable storage medium. In some implementations, the memory 520 or the non-transitory computer readable storage medium of the memory 520 stores the following programs, modules and data structures, or a subset thereof including an optional operating system 530 and an XR presentation module 540.

The operating system 530 includes procedures for handling various basic system services and for performing hardware dependent tasks. In some implementations, the XR presentation module 540 is configured to present XR content to the user via the one or more XR displays 512. To that end, in various implementations, the XR presentation module 540 includes a data obtaining unit 542, a routine executing unit 544, an XR presenting unit 546, and a data transmitting unit 548.

In some implementations, the data obtaining unit 542 is configured to obtain data (e.g., presentation data, interaction data, sensor data, location data, etc.) from at least the controller 110 of FIG. 1. To that end, in various implementations, the data obtaining unit 542 includes instructions and/or logic therefor, and heuristics and metadata therefor.

In some implementations, the routine executing unit 544 is configured to detect triggers and, in response, execute routines. To that end, in various implementations, the routine executing 544 includes instructions and/or logic therefor, and heuristics and metadata therefor.

In some implementations, the XR presenting unit 546 is configured to display XR content via the one or more XR displays 512. To that end, in various implementations, the XR presenting unit 546 includes instructions and/or logic therefor, and heuristics and metadata therefor.

In some implementations, the data transmitting unit 548 is configured to transmit data (e.g., presentation data, location data, etc.) to at least the controller 110. In some implementations, the data transmitting unit 548 is configured to transmit authentication credentials to the electronic device. To that end, in various implementations, the data transmitting unit 548 includes instructions and/or logic therefor, and heuristics and metadata therefor.

Although the data obtaining unit 542, the routine executing unit 544, the XR presenting unit 546, and the data transmitting unit 548 are shown as residing on a single device (e.g., the electronic device 120), it should be understood that in other implementations, any combination of the data obtaining unit 542, the routine executing unit 544, the XR presenting unit 546, and the data transmitting unit 548 may be located in separate computing devices.

Moreover, FIG. 5 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 5 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a head-mountable device having one or more processors and non-transitory memory;
detecting a trigger indicating that a user has mounted or dismounted the head-mountable device; and
in response to detecting the trigger, executing a routine including transmitting a request to change a state of a remote device from a first state to a second state.

2. The method of claim 1, wherein executing the routine includes transmitting requests to change a respective state of a plurality of remote devices.

3. The method of claim 1, wherein executing the routine includes playing audio.

4. The method of claim 1, wherein executing the routine includes receiving confirmation to continue the routine.

5. The method of claim 1, wherein executing the routine includes transmitting an indirect request to another device to transmit a direct request to the remote device to change the state of the remote device from the first state to the second state.

6. The method of claim 1, wherein the trigger indicates that the user has mounted the head-mountable device.

7. The method of claim 6, further comprising:
detecting a second trigger indicating that the user has dismounted the head-mountable device; and
in response to detecting the second trigger, executing a second routine including transmitting a request to change the state of the remote device from the second state to the first state.

8. The method of claim 6, further comprising:
within a predetermined time period after detecting the trigger, detecting a user request to perform a function; and
in response to detecting the user request, modifying the routine to include performing the function.

9. The method of claim 8, wherein modifying the routine is further performed in response to detecting a user confirmation of the modification.

10. The method of claim 1, wherein the trigger indicates that the user has dismounted the head-mountable device.

11. The method of claim 10, further comprising:
within a predetermined time period before detecting the trigger, detecting a user request to perform a function; and
in response to detecting the user request, modifying the routine to include performing the function.

12. The method of claim 10, further comprising:
determining a standard state of an additional remote device;
determining that a current state of the additional remote device is not the standard state; and
in response to determining that the current state of the additional remote device is not the standard state, transmitting a request to change the state of the additional remote device from the current state to the standard state.

13. The method of claim 12, further comprising modifying the routine to include transmitting the request to change the state of the additional remote device from the current state to the standard state.

14. The method of claim 1, further comprising:
determining a time the trigger is detected; and
determining that the time the trigger is detected is within a predefined time window, wherein executing the routine is further performed in response to determining that the time of detecting the trigger is within the predefined time window.

15. The method of claim 1, further comprising:
determining a location of the head-mounted device when the trigger is detected; and
determining that the location of the head-mounted device when the trigger is detected is within a predefined area, wherein executing the routine is further performed in response to determining that the location of the head-mounted device when the trigger is detected is within the predefined area.

16. A head-mountable device comprising:
a non-transitory memory; and
one or more processors to:
detect a trigger indicating that a user has mounted or dismounted the head-mountable device; and
in response to detecting the trigger, execute a routine including transmitting a request to change a state of a remote device from a first state to a second state.

17. The head-mounted device of claim 16, wherein the trigger indicates that the user has mounted the head-mountable device.

18. The head-mounted device of claim 16, wherein the trigger indicates that the user has dismounted the head-mountable device.

19. The head-mounted device of claim 16, wherein the one or more processors are further to:
determine a temporospatial condition of the device when the trigger is detected; and
determine that the temporospatial condition is within a predefined window, wherein executing the routine is further performed in response to determining that the temporospatial condition is within the predefined time window.

20. A non-transitory memory storing one or more programs, which, when executed by one or more processors of a head-mountable device, cause the head-mountable device to:
detect a trigger indicating that a user has mounted or dismounted the head-mountable device; and
in response to detecting the trigger, execute a routine including transmitting a request to change a state of a remote device from a first state to a second state.
